(19) United States
(12) Patent Application Publication
(10) Pub. No.: US 2025/0354426 A1
(43) Pub. Date: Nov. 20, 2025

(54) SYSTEM AND METHOD FOR PREVENTING FINGER OF A USER FROM PINCH IN A DOOR GAP

(71) Applicant: Mirza Faizan, Plano, TX (US)

(72) Inventors: Mirza Faizan, Plano, TX (US); Ayat Faizan, Plano, TX (US); Vihan Yerubandi, Plano, TX (US)

(21) Appl. No.: 19/281,709

(22) Filed: Jul. 27, 2025

Related U.S. Application Data
(63) Continuation-in-part of application No. 17/902,948, filed on Sep. 5, 2022, now abandoned.

(51) Int. Cl. E05F 15/40

(52) U.S. Cl. CPC E05F 15/40; E05Y 2900/132

(57) ABSTRACT

Disclosed is a method for preventing a finger of a user from pinch in a door gap. The method comprises detecting, by a machine learning (ML) model a position and trajectory of one or more fingers or hands of the user, determining, based on the detected position and trajectory, whether the one or more fingers or hands are present in, or approaching within a threshold distance of, a door gap between the frame and the moving panel, detecting a potential pinch hazard based on the determination that the one or more fingers or hands are present in, or are moving toward, the door gap within the threshold distance, generating a control signal to regulate movement of the moving panel, and actuating the door stopper mechanism in response to the control signal.

### CROSS-REFERENCE TO RELATED APPLICATION

The present non-provisional patent application is a continuation-in-part of U.S. Non-Provisional application Ser. No. 17/902,948, filed on Sep. 5, 2022.

### TECHNICAL FIELD

The present disclosure relates generally to child safety. More particularly, it relates to prevention of a finger of a child from pinch in a door gap.

### BACKGROUND

In daily life, the hand of a person specially a child may accidently put their finger in a door gap of a door. This leads to various accidents such as crushed or pinch off finger. In particular, children are more fond of play and often put their finger in the door gap. The self-care ability of the children is poor which easily make injury to the children.

Conventionally, doors are mounted in a rotational engagement using hinge pins secured to a door jamb wall. In this rotatable engagement the door is free to rotate about its hinges from an open position extending at an angle from the wall supporting a door jamb, to a closed position substantially flush with the wall and surrounded by the door jamb on four sides. Because of the size and mass of most doors and the relatively small area between the side edges of the door and the surface of the surrounding door jamb, a great amount of force may be generated by a closing door. This force combined with a perpendicular leading angle to a closing door approaching the jamb can cause severe injury to the fingers of a child or to a child's hand that is in the wrong position as the door closes. With young children in the house, and in some cases even adults, finger injuries from closing doors have become ever more common and severe injury or amputation can occur when a finger becomes caught or pinched between the leading edge of a closing door and the door jamb in the wall.

An additional concern is damage to the door and jamb themselves should any objects be intentionally or accidentally positioned between the door and jamb from a deliberate or accidental insertion. This type of problem can occur when children are playing with a door or slamming it or inserting toys or objects to prevent closure by another child.

Thus, there is a need of providing a method for automatically detecting the presence of a finger of a user in the door gap and automatically stop the panel of the door.

### SUMMARY

Consequently, there is a need for an improved method and arrangement for implementing a method and system that alleviates at least some of the above-cited problems.

It is therefore an object of the present disclosure to provide a system and a method for preventing a finger of a user from pinch in a door gap to mitigate, alleviate, or eliminate all or at least some of the above-discussed drawbacks of presently known solutions.

This and other objects are achieved using a system and a method as defined in the appended claims. The term exemplary is in the present context to be understood as serving as an instance, example or illustration.

According to the first aspect of the present disclosure, a method for preventing a finger of a user from pinch in a door gap is disclosed. The method comprises detecting a position of one or more fingers of a user using at least one sensor mounted on a door. The method further comprises determining whether the position of the one or more fingers of the user is in a door gap of the door, wherein the door gap is a gap between a frame of the door and a moving panel of the door. The method further comprises generating a signal to stop the moving panel of the door based on the determination that the position of the one or more fingers of the user is in the door gap of the door. The method further comprises transmitting the signal to a door stopper mounted on the door, wherein the signal instructs the door stopper to stop the moving door panel of the door. The method further comprises preventing a closure of the door by maintaining a distance between the frame and the moving panel of the door based on the signal.

In some embodiments, the user is a child.

In some embodiments, the at least one sensor includes one or more of a Time-of-Flight (ToF) camera, a touch sensor, a Light Detection and Ranging (LiDAR) sensor, and an ultrasonic sensor.

In some embodiments, the at least one sensor is communicatively connected to the door stopper.

In some embodiments, the at least one camera is mounted on the door at one or more of a top of the frame of the door, a bottom of the frame of the door, each side of the frame of the door, and the any portion of the moving panel of the door.

In some embodiments, an alert message is transmitted to an alarm system based on the determination that the position of the one or more fingers of the user is in the door gap of the door.

In some embodiments, the distance to be maintained between the frame and the moving panel of the door is defined by an operator of the door.

In some embodiments, the signal is transmitted to the door stopper through one of a wireless connection or a wired connection.

According to a second aspect of the present disclosure, a system for preventing a finger of a user from pinch in a door gap is disclosed. The system comprises a processor and a memory storing programmed instructions executable by the processor, wherein the processor executes the programmed instructions. The processor is configured to detect a position of one or more fingers of a user using at least one sensor mounted on a door. The processor is further configured to determine whether the position of the one or more fingers of the user is in a door gap of the door, the door gap is a gap between a frame of the door and a moving panel of the door. The processor is further configured to generate a signal to stop the moving panel of the door based on the determination that the position of the one or more fingers of the user is in the door gap of the door. The processor is further configured to transmit the signal to a door stopper mounted on the door, wherein the signal instructs the door stopper to stop the moving door panel of the door. The processor is further configured to prevent a closure of the door by maintaining a distance between the frame and the moving panel of the door based on the signal.

In some embodiments, the at least one sensor includes one or more of a Time-of-Flight (ToF) camera, a touch sensor, a Light Detection and Ranging (LiDAR) sensor, and an ultrasonic sensor.

In some embodiments, the at least one sensor is communicatively connected to the door stopper.

In some embodiments, the at least one camera is mounted on the door at one or more of a top of the frame of the door, a bottom of the frame of the door, each side of the frame of the door, and the any portion of the moving panel of the door.

In some embodiments, an alert message is transmitted to an alarm system based on the determination that the position of the one or more fingers of the user is in the door gap of the door.

In some embodiments, the distance to be maintained between the frame and the moving panel of the door is defined by an operator of the door.

In some embodiments, the signal is transmitted to the door stopper through one of a wireless connection or a wired connection.

According to a third aspect of the present disclosure, a non-transitory computer-readable storage medium for computing a desired result based on user's requirements, having stored thereon, a set of computer-executable instructions causing a computer comprising one or more processors. the one or more processors causing detecting a position of one or more fingers of a user using at least one sensor mounted on a door. One or more processors causing determining whether the position of the one or more fingers of the user is in a door gap of the door, the door gap is a gap between a frame of the door and a moving panel of the door. The one or more processors causing generating a signal to stop the moving panel of the door based on the determination that the position of the one or more fingers of the user is in the door gap of the door. The one or more processors causing transmitting the signal to a door stopper mounted on the door, wherein the signal instructs the door stopper to stop the moving door panel of the door. The one or more processors causing preventing a closure of the door by maintaining a distance between the frame and the moving panel of the door based on the signal.

In some embodiments, any of the above aspects may additionally have features identical with or corresponding to any of the various features as explained above for any of the other aspects.

An advantage of some embodiments is that alternative and/or improved approaches are provided for preventing a finger of a user from pinch in a door gap.

An advantage of some embodiments is that the problem is identified to provide the required solution for problems related to child safety.

An advantage of some embodiments is to automatically detect a finger present in the door gap.

An advantage of some embodiments is automatically stop the door panel of the door.

An advantage of some embodiments is that the door is stopped without any human intervention.

### BRIEF DESCRIPTION OF THE DRAWINGS

The foregoing will be apparent from the following more particular description of the example embodiments, as illustrated in the accompanying drawings in which reference characters refer to the same parts throughout the different views. The drawings are not necessarily to scale, emphasis instead being placed upon illustrating the example embodiments.

FIG. 1 illustrates a diagram of a door installed in a room, according to some embodiments of the present invention.

FIG. 2 illustrates presence of fingers in the door gap of the door, according to some embodiments of the present invention.

FIG. 3 illustrates a block diagram of system for preventing a finger of a user from pinch in a door gap, according to some embodiments of the present invention.

FIG. 4 illustrates a flow diagram of method steps for preventing a finger of a user from pinch in a door gap, according to some embodiments of the present invention.

FIG. 5 illustrates an example computing environment implementing a method and the processing node for preventing a finger of a user from pinch in a door gap, according to some embodiment of the present invention.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an”, and “the” are intended to include the plural forms as well, unless the context clearly indicates otherwise.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services, and functions disclosed herein when executed by the one or more processors.

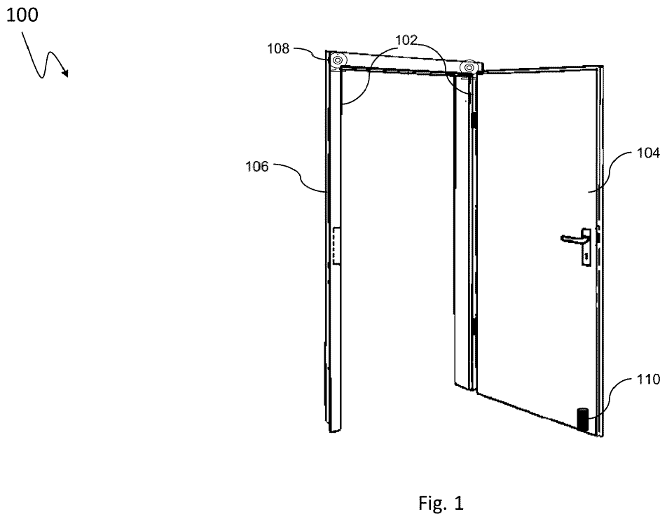

FIG. 1 illustrates a diagram of a door 100 installed in a room, according to some embodiments of the present invention. Some of the examples of the door 100 may include, but not limited to, a slide door, a latch door, and a revolving door. The door 100 may comprise a door gap 102, a door panel 104, a frame 106, one or more sensors 108, and a door stopper 110. The door gap 102 may be present at both ends of the frame 106 of the door 100. The door gap 102 may be adapted to accommodate the door panel 104 of the door 100. The door panel 104 may be present in a vertical direction. The door panel 104 may be adapted to move in rotational direction for closing and opening the door 100.

The sensor 108 may include, but not limited to, a Time-of-Flight (ToF) camera, a touch sensor, a Light Detection and Ranging (UDAR) sensor, and an ultrasonic sensor. The sensor 108 may be present at different positions on the frame 106 of the door 100. In one implementation, the sensor 108 may be present at top-right corner of the frame 106 of the door 100. In another embodiment, the sensor 108 may be present at top-left corner of the frame 106 of the door 100. In another embodiment, the sensor 108 may be present at top-left as well as top-right corner of the frame 106 of the door 100.

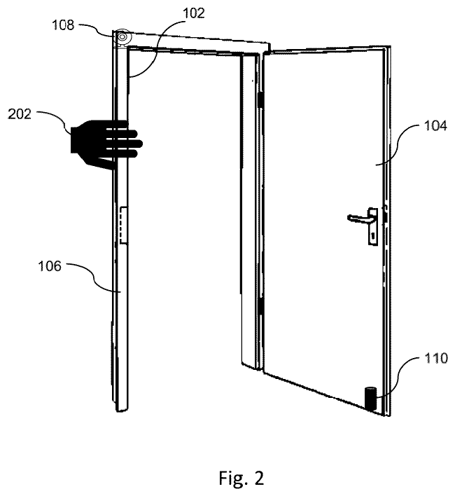

FIG. 2 illustrates presence of fingers 202 in the door gap 102 of the door 100, according to some embodiments of the present invention. The sensor 108 may be configured to detect presence of fingers 202 in the door gap 102 of the door 100. For example, the sensor 108 may be positioned such that a field of view of the sensor 108 is same as door gap 102 of the door 100. When any part of body (such as a finger 202) of the user (such as a child) is detected in the field of view of the sensor 108.

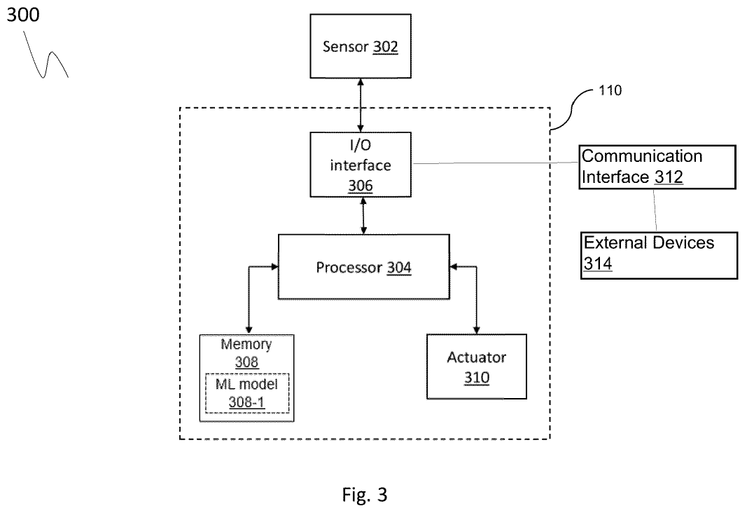

The sensor 108 may transmit a signal to a door stopper 110 of the door. The door stopper 110 may be configured to stop the movement of the door panel 106. Various components of the door stopper 110 has been described with reference to FIG. 3.

As illustrated in FIG. 3, the door stopper 110 may receive a signal from sensors 302 (similar to the sensor 108 as illustrated in FIGS. 1 and 2). The sensors 302 may be configured to sense or detect presence of a user's hand in door gap 102 of the door 100. The door stopper 110 may comprise a processor 304, an I/O interface 306, a memory 308, and an actuator 310. The memory may further store a trained machine learning (ML) model 308-1.

In an embodiment, the sensors 302 may be strategically mounted on both the frame 106 and the moving panel 104 of the door 100. The sensors 302 capture images of the hand 202 of the use from multiple angles, thereby minimizing occlusion and enhancing detection accuracy by the ML model 308-1.

In some embodiments, the sensors 302 may include depth cameras, RGB cameras, Time-of-Flight (ToF) cameras, or stereo camera pairs. The present disclosure may utilize at least four to six sensors positioned as follows: (i) one or more sensors at the top of the door frame 106, angled downward to cover the upper region of the door gap and the hand of the user from above, (ii) one or more sensors at the bottom of the frame 106, angled upward to capture the underside of the hand or fingers, (iii) one sensor each on the left and right vertical edges of the door frame 106, facing inward toward the door gap to monitor lateral motion of fingers, (iv) one sensor on the moving panel itself, directed outward toward the gap to detect hands approaching from the closing side.

These positions provide a 360-degree composite field of view around the door gap, ensuring that hand and finger movements are visible from at least three distinct angles at any given moment. This multi-view imaging enables the ML model 308-1 to accurately estimate finger and palm orientation, depth and proximity relative to the gap, velocity and trajectory of movement, and/or partial occlusions due to door structure or user posture.

Captured images from each sensor are time-synchronized and optionally fused into a combined 3D model or fed into the ML inference pipeline separately. This redundancy improves robustness in variable lighting or motion blur scenarios.

In some embodiments, the image resolution and frame rate are selected to allow the ML model to detect subtle finger movements, such as a child reaching slowly toward the door. For example, a frame rate of at least 30 fps and a resolution of 640×480 pixels or higher may be employed.

The processor 304 may receive the signal from the sensors 302 through the i/O interface 306. The signal may indicate presence of user's hand in the door gap 102 of the door 100. The processor 304 may be communicatively coupled with the memory 308. The memory 308 may be configured to store programmed instructions executable by the processor 304. The processor 304 may execute the programmed instructions to perform one or more steps for preventing user's finger from pinching in a door gap 102.

In one or more embodiments, the processor 304 may detect a position of one or more fingers of a user using at least one sensor mounted on a door. The processor 304 may further determine whether the position of the one or more fingers of the user is in a door gap of the door. The door gap is a gap between a frame 106 of the door and a moving panel of the door. The processor 304 may further determine generate a signal to stop the moving panel of the door based on the determination that the position of the one or more fingers of the user is in the door gap of the door. The processor 304 may further transmit the signal to the actuator 310. The signal instructs the actuator 310 to stop the moving door panel 104 of the door 100.

In an additional embodiment, detection of the finger 202 near a hazardous region, such as the door gap 102, begins with the ML model 308-1 using the images captured by the sensors 302 for the hand or finger 202 recognition. The ML model 308-1 is built using datasets of annotated hand or finger 202 images under various lighting conditions, angles, and proximities. The ML model 308-1 may incorporates an edge-aware image recognition algorithm that helps in segmenting fine contours of the fingers 202 and hands even against complex backgrounds like surfaces of the door 100. The ML model 308-1 operates on real-time data acquired from the plurality of sensors 302 mounted on both the frame 106 and the door panel 104 of the door 100.

Once the position and trajectory are determined, the processor 304 uses this information to evaluate whether the detected fingers 202 or hands are either located within or approaching a threshold distance from the door gap 102. The threshold distance may refer to a predefined spatial margin surrounding the door gap 102, calibrated to ensure early intervention before any part of the hand can be pinched. The processor 304 considers not just the position but also the rate and direction of movement to evaluate whether the trajectory intersects this protected margin. If the processor 304 determines that the fingers 202 or hands are within or moving toward this margin, the system flags the event as a potential pinch hazard. The potential pinch hazard may be defined as a condition in which the spatial and motion parameters of the hand or finger 202 indicate imminent contact with a moving part of the door 100 near the door gap 102, thus requiring preventive action.

Upon detecting this hazard, the processor 304 generates a control signal that regulates the movement of the moving door panel 104. This signal contains information related to both proximity and dynamic factors, such as closing speed. The control signal is immediately transmitted to door stopper mechanism, which is mounted either on the door panel 104 or along the frame 106. The door stopper mechanism is a safety and control component that regulates or restricts the movement of the door panel 104. It can absorb force, halt motion, or provide variable resistance to prevent sudden closure, especially in response to detected hazards. The door stopper mechanism may comprise the door stopper 110, the plurality of sensors 302 for feedback, and the I/O interface 306. The door stopper 110 receives the signal and initiates an actuation response that includes applying variable resistance to the motion of the door panel 104. The variable resistance may be defined as a controllable level of mechanical or electro-mechanical resistance applied by the door stopper 110, which increases or decreases based on real-time factors like the proximity of the fingers to the door gap and the current speed of door movement. For example, if the fingers 202 are extremely close and the door 100 is closing rapidly, the resistance level is increased substantially to bring the door panel 104 to a controlled halt.

The variable resistance profile is managed by actuators 310 capable of modulating braking force or mechanical impedance in response to changing inputs. Along with this, the system features an operator interface that enables a user to specify a user-defined value, which corresponds to a minimum allowable distance between the frame 106 and the door panel 104. In an embodiment, the I/O interface 306 may perform the functions desired by the operator interface. In another embodiment, the operator interface may include the I/O interface 306. The operator interface may refer to a user-facing component that allows a person (such as the child's guardian, technician, or system operator) to interact with the system. It may include a touch screen panel, voice command interface, mobile app interface or any graphical user interface. The operator interface may allow users to give commands (e.g., halt/resume the door), set preferences (like minimum gap distance), or receive alerts (e.g., hazard detected). The user-defined value is a parameter input by the user or installer that sets a fixed safety buffer distance to be maintained between the panel 104 and the frame 106 when a pinch hazard is detected. The user-defined value or minimum door gap distance may vary depending on the type of the door 100 or intended application (e.g., home, daycare, hospital). The processor 304 stores and uses the user-defined value or minimum door gap distance to determine the stopping position of the door 100. When a hazard is confirmed, the processor 304 sends a signal to the door stopper 110 to halt the movement of the panel 104 before the door gap 102 and ensures the set minimum door gap distance between the panel 104 and the frame 106. By doing so, the processor 304 effectively prevents closure of the door 100, thereby maintaining the specified safe clearance between the frame 106 and the door panel 104.

Additionally, the ML model 308-1 may comprise an edge-aware image recognition algorithm capable of distinguishing the finger 202 outlines in proximity to high-contrast surfaces such as the frame 106 or the door panel 104 of the door 100. The ML model 308-1 may be trained on a large dataset of annotated images depicting the hands or fingers 202 approaching near the door gaps 102 from multiple angles, lighting conditions, and spatial configurations. Based on real-time input from the plurality of the sensors 302 mounted on the frame 106 and on the door panel 104, the ML model 308-1 is capable of inferring both the current position and the anticipated trajectory of the fingers 202. This inference capability enables the processor 304 to detect a potential pinch risk proactively, even before physical contact with the door gap 102 occurs.

The determination of such potential pinch risk proactively may be performed by executing the ML model 308-1 on the processor 304. The ML model 308-1 is trained using labeled datasets that include variations in the hand postures, motion vectors, and approach trajectories toward door gaps. During real-time operation, the ML model 308-1 classifies each input instance as “safe” or “unsafe” by comparing it against learned motion patterns. The ML model 308-1 may utilize convolutional neural networks (CNNs) for spatial analysis of image data and recurrent neural networks (RNNs) to track and predict movement sequences over time. This allows the processor 304 to continuously monitor the finger 202 or hand presence and dynamically assess the likelihood of a pinch hazard with both spatial and temporal accuracy.

In some embodiments, the processor 304 may further enhance safety by forecasting potential obstruction events before they occur. This safety is accomplished by continuously monitoring and analyzing historical movement patterns of users or objects near the door using the ML model 308-1 stored in the memory 308 and executed by the processor 304. The ML model 308-1 may be trained on time-series datasets capturing user interactions with the door over multiple sessions, such as frequent hand placements near the door gap, habitual child play areas, or routine paths of movement near the doorway.

By learning these recurring behavioral patterns, the ML model 308-1 identifies temporal and spatial trends that suggest a likely obstruction event, such as the hand frequently appearing at a specific time or location relative to the door panel 104. Upon detection of such predictive conditions, the processor 304 proactively generates the control signal to regulate the movement of the door panel 104. This control signal ensures that even if the fingers 202 are not yet in the door gap 102, the processor 304 may still initiate a safety response, such as slowing down or temporarily halting the door panel 104. This approach enhances the overall safety architecture by reducing reaction time and increasing preventive responsiveness, thereby minimizing the risk of injury or damage.

In some embodiments, the processor 304 may further be integrated with external environmental monitoring devices to enhance safety and operational response. This integration may allows the processor 304 to receive environmental data or status signals from external devices such as a fire alarm panel, a Heating, Ventilation, and Air Conditioning (HVAC) control unit, or a central emergency evacuation system. These incoming data streams are received via the I/O interface 306, which facilitates interoperability between the door control system and external building infrastructure.

The processor 304 evaluates the received data, such as a fire alarm being triggered, an HVAC unit operating in a high-pressure state, or the initiation of an emergency evacuation protocol, to determine the contextual need for altering door behavior. Based on this evaluation, the processor 304 dynamically generates the control signal to regulate the movement of the door panel 104. For instance, if an emergency evacuation is underway, the processor 304 may instruct the door stopper mechanism to override standard safety delays and allow faster opening. Conversely, during the hazardous environmental conditions (e.g., excessive smoke or HVAC overpressure), the door 100 may be held open or closed to maintain environmental integrity or user safety. This capability ensures that door 100 movement is context-aware and coordinated with broader building safety requirements, thereby achieving more intelligent and situationally responsive control.

The actuator 310 may comprise one or more components for blocking the movement of the door panel 104. When the actuator 310 receives the signal to stop the movement of the door panel 104, it automatically restricts the movement of the door panel 104, thereby preventing the user's finger from pinch in the door gap 102. For example, the actuator 310 may be comprised with a mechanism which move downward and couple with the ground to restrict the movement of the door panel 104.

Additionally, the door stopper mechanism may include a variable resistance actuator that is specifically configured to dynamically modulate the amount of mechanical resistance applied to the moving panel of the door. The function of the actuator 310 is to oppose the closing force of the moving panel in a controlled manner whenever a potential pinch hazard is detected. The actuator 310 receives real-time data regarding both the proximity of one or more fingers 202 or hands to the door gap 102 and velocity of the door panel 104, which are analyzed by the processor 304 executing the ML model 308-1 trained to infer safety conditions. Based on these two parameters, the actuator 310 increases or decreases resistive force accordingly, allowing the door 100 to decelerate smoothly or stop entirely if necessary.

The variable resistance actuator 310 may be realized using a variety of electromechanical or fluidic systems, each selected to meet specific application constraints such as size, response time, or force resolution. In some embodiments, the actuator 310 may comprise a stepper motor with torque control, such that discrete step positions allow precise modulation of rotational resistance against the hinge of the door 100. In other configurations, an electromagnetic brake may be employed, which applies variable braking torque in proportion to the strength of an induced magnetic field, offering near-instantaneous resistance with no mechanical wear. Alternatively, a servo motor with force feedback may be used to enable closed-loop resistance control, dynamically adjusting the applied counterforce in response to both panel speed and finger proximity.

In applications where pneumatic actuation is preferred due to its smooth and compliant behavior, a pneumatic actuator with controllable pressure output may be utilized. This setup allows the resistance to be adjusted by varying the internal air pressure based on sensor inputs, offering a soft-stopping characteristic especially useful in public or high-traffic environments. In yet another embodiment, a magnetorheological damper may be employed. This type of actuator 310 uses a fluid whose viscosity changes in response to an applied magnetic field, enabling continuous and high-bandwidth modulation of resistance. The magnetic field strength is controlled in real time by the processor 304 to match both the proximity of the fingers 202 to the door gap 102 and the motion profile of the door 100.

The user may be a child or any person who can accidently put their finger in the door gap 102. The sensor 302 may include one or more of a Time-of-Flight (ToF) camera, a Light Detection and Ranging (LiDAR) sensor, and an ultrasonic sensor. The sensor 302 may be mounted on the door 100 at one or more of a top of the frame 106 of the door 100, a bottom of the frame 106 of the door 100, each side of the frame 106 of the door 100, and the any portion of the moving panel of the door 100.

The system may further comprise an alarm system which transmits an alarm message or generate alarm sounds when it is determined that the user's finger is present in the door gap 102 of the door 100. The distance to be maintained between the frame 106 and the moving panel 104 of the door 100 is defined by an operator of the door 100. The signal may be transmitted to the door stopper 110 through one of a wireless connection or a wired connection.

In an additional embodiment, the processor 304 may include functionality for receiving voice commands from the user through the operator interface, enabling manual override of the door stopper mechanism. This feature serves the important purpose of granting the user situational control over the automated operation of the door 100, especially in scenarios where the processor 304 may detect a potential pinch hazard inaccurately or where the user intends to override a safety pause, such as during maintenance, object transport, or intentional obstruction by the user. To achieve this, the operator interface may be equipped with a microphone array or an embedded voice recognition module capable of detecting predefined wake words and command structures.

When the user issues a command, such as “resume door” or “halt door”, the operator interface transmits the voice data to a local or cloud-based speech recognition engine. This cloud-based speech recognition engine may process the audio input using natural language processing (NLP) techniques and match it against an authorized command list. Upon successful recognition, a corresponding override instruction is generated and relayed to the processor 304. The processor 304 then either disables the safety hold and resumes door motion (in the case of a “resume” command), or forcibly halts door movement (in the case of a “half” command), overriding the automatic response initiated by the ML model 308-1.

In one or more embodiments, the operator interface also provides user-specific customization to accommodate the varying safety needs of different individuals, such as children, elderly users, or those with limited mobility. By receiving such input, the operator interface allows the processor 304 to define a personalized safety profile that may include parameters such as a preferred minimum door gap distance, a sensor sensitivity threshold, and a movement prediction tolerance.

The preferred minimum door gap distance ensures that a safe physical clearance is maintained based on dimensions of the hand or finger 202, preventing accidental contact with the moving door panel 104. The sensor sensitivity threshold refers to the minimum detectable level of input, such as proximity, motion, or presence, that the sensor must register before triggering a response. This parameter governs how quickly and precisely the processor 304 reacts to the detection of the hands or fingers 202 near the door gap 102, with higher sensitivity offering quicker detection and lower sensitivity reducing the likelihood of false triggers. Additionally, the movement prediction tolerance defines how much deviation from expected movement trajectories the processor 304 will accept before initiating a safety response. This helps in balancing the responsiveness of the processor 304 to real hazards without overreacting to normal, non-threatening variations in movement.

Once defined, these personalized settings are stored in the memory 308 and referenced by the processor 304 during real-time operation. As a result, the door system dynamically adapts its behavior to align with the preferences of the user, thereby enhancing both safety and user experience in a context-aware manner.

Additionally, parameters of the personalized safety profile are not only defined by the user but are actively retrieved and applied in real time as functions of the door 100. This enhances ability of the processor 304 to adapt to individual safety needs continuously, thereby reducing the risk of injury and increasing user confidence in the system.

Once the personalized safety profile has been created and stored in the memory 308 containing user-defined inputs such as a preferred minimum door gap distance, sensor sensitivity threshold, and movement prediction tolerance, the processor 304 accesses this profile during the operational cycle of the door 100. Upon retrieval, the processor 304 modifies parameters to align with the personalized configuration. These modifications may include adjusting the threshold distance used to detect a potential pinch hazard. For example, the profile of the child may set a longer threshold distance to trigger early intervention, while an adult profile might permit closer proximity before intervention. By retrieving and applying these profile-based modifications, the processor 304 ensures proactive and individualized safety behavior.

In an additional embodiment, the processor 304 may transmit notifications to external devices 314 or application associated with the user upon detecting a potential pinch hazard. This enhances situational awareness and user safety by ensuring that hazard events are communicated beyond the door system itself, particularly useful in contexts where a caregiver, parent, or safety monitoring service needs to be informed in real time.

Once the processor 304 identifies that a potential pinch hazard exists, based on the ML model 308-1 inference and sensor data analysis, the control signal is not only generated to regulate the movement of the door panel but is also used to initiate a communication sequence. The processor 304, through a communication module 312 integrated within the processor 304, sends an alert to external devices 314 such as a smartphone, tablet, wearable device, or a building automation application. The alert may include relevant data such as timestamp, location, image capture (if supported), or severity of the hazard. The transmission can occur over wireless protocols like Wi-Fi, Bluetooth, or Zigbee, depending on system design.

This capability allows external systems or responsible individuals to intervene or log incidents, thereby adding a layer of remote monitoring and post-event analysis. In safety environments like schools, hospitals, or assisted living facilities, this real-time alerting function helps ensure rapid response and better risk mitigation.

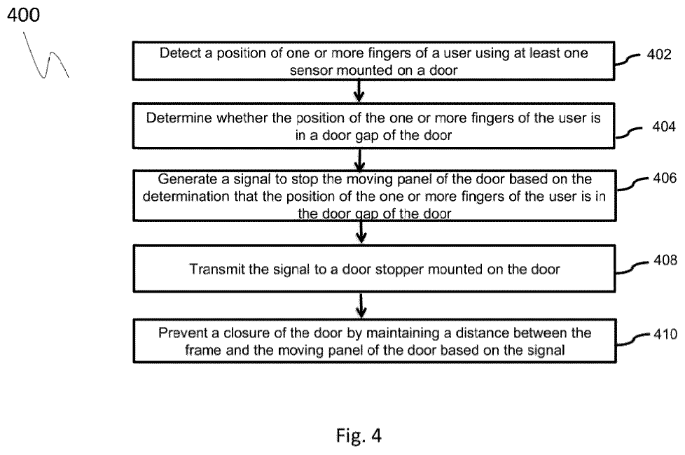

FIG. 4 illustrates a flow diagram of method steps for preventing a finger of a user from pinch in a door gap, according to some embodiments of the present invention. A position of one or more fingers of a user may be detected using at least one sensor mounted on a door, at step 402. It may be determined whether the position of the one or more fingers of the user is in a door gap of the door, at step 404. The door gap is a gap between a frame of the door and a moving panel of the door. A signal to stop the moving panel of the door may be generated based on the determination that the position of the one or more fingers of the user is in the door gap of the door, at step 406. The signal may be transmitted to a door stopper mounted on the door, at step 408. The signal instructs the door stopper to stop the moving door panel of the door. A closure of the door may be prevented by maintaining a distance between the frame and the moving panel of the door based on the signal, at step 410.

The user may be a child or any person who can accidently put their finger in the door gap. The sensor may include one or more of a Time-of-Flight (ToF) camera, a Light Detection and Ranging (UDAR) sensor, and an ultrasonic sensor. The sensor may be mounted on the door at one or more of a top of the frame of the door, a bottom of the frame of the door, each side of the frame of the door, and the any portion of the moving panel of the door.

An alarm system may be present which transmits an alarm message or generate alarm sounds when it is determined that the user's finger is present in the door gap of the door. The distance to be maintained between the frame and the moving panel of the door is defined by an operator of the door. For example, the distance to be maintained by the processor is predefined by used and whenever the processor detects the finger, it instructs the door stopper to stop the door to maintain that predefined distance. The signal may be transmitted to the door stopper through one of a wireless connection or a wired connection.

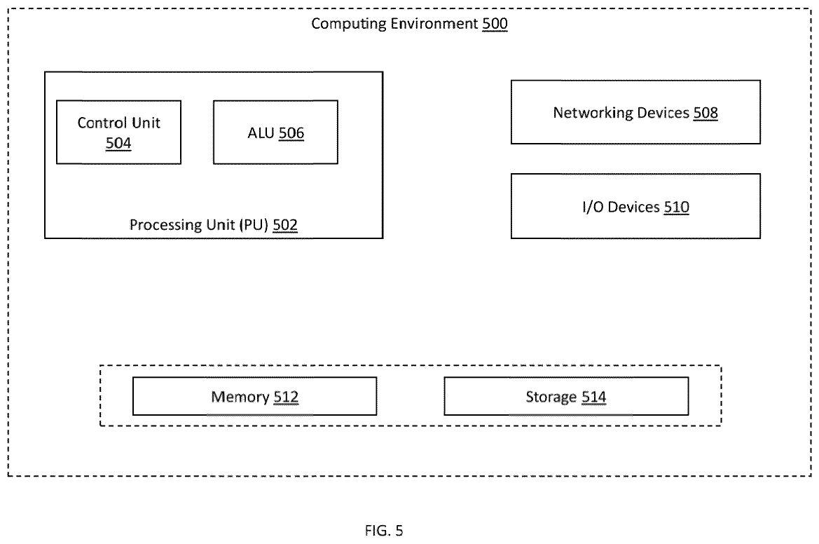

FIG. 5 illustrates an example computing environment 500 implementing a method and the processing node for preventing a finger of a user from pinch in a door gap, according to some embodiment of the present invention. The computing environment 500 may be coupled with the door stopper of the door. As depicted in FIG. 5, the computing environment 500 comprises at least one processing unit 502 that is equipped with a control unit 504 and an Arithmetic Logic Unit (ALU) 506, a plurality of network devices 508 and a plurality Input-output, I/O devices 510, a memory 512, and a storage 514. The processing unit 502 may be responsible for implementing the method described in FIG. 4. For example, the processing unit 502 may in some embodiments be equivalent to the processor of the processing node and the server described above in conjunction with the FIG. 4. The processing unit 502 is capable of executing software instructions stored in memory 512. The processing unit 502 receives commands from the control unit 504 in order to perform its processing. Further, any logical and arithmetic operations involved in the execution of the instructions are computed with the help of the ALU 506.

The computer program is loadable into the processing unit 502, which may, for example, be comprised of an electronic apparatus (such as a UE or a network node). When loaded into the processing unit 502, the computer program may be stored in the memory 512 associated with or comprised in the processing unit 502. According to some embodiments, the computer program may, when loaded into and run by the processing unit 502, cause execution of method steps according to, for example, any of the methods illustrated in FIG. 4 or otherwise described herein.

The overall computing environment 500 may be composed of multiple homogeneous and/or heterogeneous cores, multiple CPUs of different kinds, special media, and other accelerators. Further, the plurality of processing unit 502 may be located on a single chip or over multiple chips.

The algorithm comprising of instructions and codes required for the implementation are stored in either the memory 512 or the storage 514 or both. At the time of execution, the instructions may be fetched from the corresponding memory 512 and/or storage 514 and executed by the processing unit 502.

In case of any hardware implementations various networking devices, 508 or external I/O devices 510 may be connected to the computing environment to support the implementation through the networking devices 508 and the I/O devices 510.

The embodiments disclosed herein can be implemented through at least one software program running on at least one hardware device and performing network management functions to control the elements. The elements shown in FIG. 5 include blocks that can be at least one of a hardware device or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user's computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer-readable media such as RAMs, ROMs, flash memory, EEPROMs, optical devices (CD or DVD), hard drives, and floppy drives, or any suitable device. The computer-executable component can be a processor but any suitable dedicated hardware device can (alternatively or additionally) execute the instructions.

As a person skilled in the art will recognize from the previous detailed description and the figures and claims, modifications and changes can be made to the embodiments of the invention without departing from the spirit and scope of this invention as defined in the following claims.

What is claimed is:

1. A method for preventing a finger of a user from pinch in a door gap, the method comprising:
detecting, by a machine learning (ML) model trained for hand and finger recognition and comprising an edge-aware image recognition algorithm, a position and trajectory of one or more fingers or hands of the user, using images captured by a plurality of sensors mounted on a frame and a moving panel of a door;
determining, based on the detected position and trajectory, whether the one or more fingers or hands are present in, or approaching within a threshold distance of, a door gap between the frame and the moving panel;
detecting a potential pinch hazard based on the determination that the one or more fingers or hands are present in, or are moving toward, the door gap within the threshold distance;
generating a control signal to regulate movement of the moving panel based on the detected potential pinch hazard;
transmitting the control signal to a door stopper mechanism;
actuating the door stopper mechanism in response to the control signal and providing, by the door stopper mechanism, variable resistance to the movement of the moving panel based on a proximity of the one or fingers or hands to the door gap, and a speed of the moving panel;
receiving, via an operator interface, a user-defined value corresponding to a minimum door gap distance to be maintained when the potential pinch hazard is detected; and
preventing closure of the door by maintaining the minimum door gap distance between the frame and the moving panel in accordance with the user-defined value.

2. The method of claim 1, wherein the ML model is trained on annotated image datasets of human hands and fingers in various positions relative to the door gap, and comprises edge-aware segmentation algorithms configured to detect finger boundaries near high-contrast regions.

3. The method of claim 1, wherein the door stopper mechanism comprises a variable resistance actuator configured to dynamically adjust the resistance to the movement of the moving panel based on both the proximity of the one or more fingers or hands to the door gap and the speed of the moving panel.

4. The method of claim 3, wherein the variable resistance actuator comprises one or more of:
a stepper motor with torque control,
an electromagnetic brake,
a servo motor with force feedback,
a pneumatic actuator with controllable pressure output, or
a magnetorheological damper configured to vary resistance based on an applied magnetic field.

5. The method of claim 1, further comprising:
receiving a voice command from the user through the operator interface; and
causing overriding of the door stopper mechanism to resume or halt the movement of the moving panel, based on the received voice command.

6. The method of claim 1, further comprising:
predicting an obstruction event based on historical movement patterns of the user or objects near the door; and
generating the control signal to regulate the movement of the moving panel based on the predicted obstruction event.

7. The method of claim 1, further comprising:
receiving environmental data or status signals from an external device; and
generating the control signal to regulate the movement of the moving panel based on the received environmental data or status signals, wherein the environmental data includes one or more of: fire alarm status, Heating, Ventilation, and Air Conditioning (HVAC) activity, or emergency evacuation protocols.

8. The method of claim 1, wherein the operator interface is configured to receive input from the user, and define, based on the received input, a personalized safety profile including at least one of a preferred minimum door gap distance, a sensor sensitivity threshold, or a movement prediction tolerance.

9. The method of claim 8, further comprising:
retrieving the personalized safety profile during operation of the door; and
modifying at least one of the threshold distance for detecting the potential pinch hazard, the variable resistance applied by the door stopper mechanism, or the minimum door gap distance to be maintained, in accordance with the retrieved personalized safety profile.

10. The method of claim 1, further comprising:
transmitting, upon detection of the potential pinch hazard, an alert to an external device or application associated with the user.
